(19) United States
(12) Patent Application Publication
(10) Pub. No.: US 2026/0097789 A1
(43) Pub. Date: Apr. 9, 2026

(54) METHOD AND CONTROL UNIT FOR GENERATING A TRAJECTORY FOR A VEHICLE

(71) Applicant: Robert Bosch GmbH, Stuttgart (DE)

(72) Inventors: Alexander Brickwedde, Bramsche (DE); Armin Joos, Stuttgart (DE); Felix Kunz, Stuttgart (DE); Jattin Sangwan, Leinfelden-Echterdingen (DE); Vasundhara Jain, Stuttgart (DE)

(21) Appl. No.: 19/343,515

(22) Filed: Sep. 29, 2025

(30) Foreign Application Priority Data
Oct. 4, 2024 (DE) 10 2024 209 714.4

(51) Int. Cl. B60W 60/00

(52) U.S. Cl. CPC B60W 60/0011

(57) ABSTRACT

A method for generating a trajectory for a vehicle. A driving task to be completed by the trajectory is simplified by extracting nonlinear and discontinuous constraints and eliminating them from the driving task in order to obtain a simplified driving task. The simplified driving task is subdivided into at least two different subproblems, and a reference profile is created for one of the subproblems. At least two trajectory candidates for the subproblem are determined using the reference profile. A comparison of the trajectory candidates with the previously eliminated constraints is carried out. The trajectory to be executed for the vehicle is selected using a result of the comparison.

### CROSS REFERENCE

The present application claims the benefit under 35 U.S.C. § 119 of Germany Patent Application No. DE 10 2024 209 714.4 filed on Oct. 4, 2024, which is expressly incorporated herein by reference in its entirety.

### FIELD

The present invention relates to a method for generating a trajectory for a vehicle, to a corresponding control unit, and to a corresponding computer program product.

### BACKGROUND INFORMATION

An autonomous or semiautonomous vehicle is steered along a predetermined trajectory. The trajectory is intended to guide the vehicle without conflict through an environment, in particular with other road users, while fulfilling a specified driving task. For example, the trajectory consists of a path for the vehicle and time information on this path.

Different methods can be used to calculate the trajectory. For example, as many trajectory candidates as possible can be created and then each one can be checked for its feasibility. From the remaining trajectory candidates, the ultimately most advantageous trajectory for fulfilling the driving task can then be selected using a cost evaluation. This method requires a large amount of computing resources and can be carried out, for example, in a computing center networked to the vehicle. Driving tasks of other road users can also be taken into account directly in order to resolve conflicts cooperatively.

Only limited computing resources are available in the vehicle itself. This means, for example, that only a few trajectory candidates can be created and checked.

### SUMMARY

The present invention provides a method for generating a trajectory for a vehicle, a corresponding control unit, and a corresponding computer program product. Advantageous developments and improvements of the present invention here emerge from the description and are disclosed herein.

The present invention simplifies a complex driving task by excluding complex boundary conditions. The simplified driving task is then subdivided into subtasks in order to obtain tasks that are even easier to complete. For one of the subtasks, trajectory candidates are created and checked using the previously excluded boundary conditions. The most advantageous trajectory candidate is selected as the trajectory. In particular, the next subtask to be processed is selected to create trajectory candidates.

The present invention presented here allows a complex driving task to be completed step by step with limited computing resources.

According to an example embodiment of the present invention, a method for generating a trajectory for a vehicle is provided, wherein a driving task to be completed by the trajectory is simplified by extracting nonlinear and discontinuous constraints and eliminating them from the driving task in order to obtain a simplified driving task, wherein the simplified driving task is subdivided into at least two different subproblems, and a reference profile for solving the subproblem is created for one of the subproblems, wherein at least two trajectory candidates for the subproblem are determined using the reference profile, wherein a comparison of the trajectory candidates with the previously eliminated constraints is carried out, and the trajectory to be executed for the vehicle is selected using a result of the comparison.

Ideas for embodiments of the present invention may be considered, inter alia, as being based on the concepts and findings described below.

A trajectory can be a two-dimensional or three-dimensional path with time information or speed information along the path. The trajectory can specify where a vehicle will be and when it will be there or should be there. The trajectory can be followed by an autonomous or semiautonomous vehicle without intervention by a driver.

A driving task can define a destination for the vehicle. The driving task can in particular define an intermediate destination. The driving task can, for example, be specified by a planned route from a navigation system. The driving task can comprise a limited section of the route to the intermediate destination. For example, the driving task can comprise two or more route points along the route. The extent of the driving task can, for example, be limited by a detection range of sensors on the vehicle. The driving task can conflict with a traffic situation and/or an environment around the vehicle.

A nonlinear and/or discontinuous constraint can result from the conflict with the traffic situation and/or the environment. The constraint can, for example, be an uncertainty in predicting the behavior of other road users and/or infrastructure objects. By eliminating the nonlinear and discontinuous constraints, the driving task can be significantly simplified.

A subproblem can be a subtask of the simplified driving task. The subproblem can exclude other parts of the driving task. The subproblem can contain only one aspect of the driving task. The subproblem can also comprise only a portion of the driving task. The selected subproblem can be the next subproblem to be solved. Once the subproblem has been solved, the following subproblem can be solved.

A reference profile can be an unoptimized trajectory candidate that solves the subproblem, for example, in a direct way. The reference profile can be created quickly because it cannot be selected as a trajectory candidate. The reference profile can serve as a rough guide when determining the trajectory candidates.

A trajectory candidate can have a higher complexity than the reference profile. When the trajectory candidate is created, more boundary conditions can be met than for the reference profile. Each trajectory candidate can actually be driven by the vehicle.

During the comparison with the previously eliminated constraints, a search is carried out for trajectory candidates with conflicts. For example, the trajectory candidate that has the fewest conflicts or is conflict-free is selected as the trajectory to be executed. If the selected trajectory candidate has conflicts, it can still be optimized to become conflict-free. The comparison can be made using a cost analysis. The most advantageous trajectory candidate can incur the lowest cost given the constraints.

A current importance can be determined for each subproblem. The reference profile can be created for the subproblem with the currently highest importance. By weighting the subproblems, currently unimportant subproblems can be ignored or postponed. The ignored subproblems can be considered in later runs.

The importance of each subproblem can be determined using a heuristic based on a current traffic situation. A heuristic can represent the current traffic situation in numerical values. The heuristic can thus ensure comparability of the subproblems.

The reference profile can be created with reduced requirements in comparison with the corresponding subproblem. To create the reference profile, certain requirements present in the subproblem can be omitted. As a result, the reference profile can be created quickly and efficiently. The reference profile can therefore be unsuitable for driving with the vehicle but can serve as the basis for the trajectory candidates which then take the omitted requirements into account again.

A feasibility of the reference profile can be checked. The method can be aborted and restarted if the reference profile is not feasible. For example, it can be checked whether the reference profile would lead to a collision with infrastructure facilities because, for example, the reference profile intersects a curve and/or runs through the infrastructure object. This reference profile is then unsuitable for deriving trajectory candidates from it, and it is better to start from scratch rather than wasting resources on unsuitable trajectory candidates.

The trajectory candidates can be derived from the reference profile by varying at least one parameter of the reference profile. Alternatively or additionally, the trajectory candidates can be derived from the reference profile by varying a number of parameters of the reference profile. The reference profile can be greatly simplified. By varying and/or adding parameters, the complexity of the trajectory candidates can be increased in comparison with the reference profile.

The method of the present invention is preferably computer-implemented and can be implemented, for example, in software or hardware or in a mixed form of software and hardware, for example in a control unit.

The approach presented here according to the present invention furthermore provides a control unit, wherein the control unit is designed to carry out, control, or implement, in corresponding devices, the steps of a variant of the method of the present invention presented here.

According to an example embodiment of the present invention, the control unit can be an electrical unit comprising at least one computing unit for processing signals or data, at least one memory unit for storing signals or data, and at least one interface and/or one communication interface for reading in or outputting data embedded in a communication protocol. The computing unit can, for example, be a signal processor, a so-called system ASIC, or a microcontroller for processing sensor signals and outputting data signals depending on the sensor signals. The memory unit can, for example, be a flash memory, an EPROM, or a magnetic memory unit. The interface can be designed as a sensor interface for reading in the sensor signals from a sensor and/or as an actuator interface for outputting the data signals and/or control signals to an actuator. The communication interface can be designed to read in or output the data in a wireless and/or wired manner. The interfaces may also be software modules that are present, for example, on a microcontroller in addition to other software modules.

A computer program product or a computer program, which has program code that can be stored on a machine-readable carrier or storage medium, such as a semiconductor memory, a hard disk memory, or an optical memory, and that is used for carrying out, implementing, and/or controlling the steps of the method according to one of the embodiments of the present invention described above, in particular when the program product or program is executed on a computer or an apparatus, is advantageous as well.

It is pointed out that some of the possible features and advantages of the present invention are described herein with reference to different embodiments. A person skilled in the art recognizes that the features of the control unit and of the method can be suitably combined, adapted or replaced in order to arrive at further embodiments of the present invention.

### BRIEF DESCRIPTION OF THE DRAWING

Embodiments of the present invention are described below with reference to the figures, and neither the figure nor the description should be construed as limiting the present invention.

FIG. 1 shows a method sequence of a method according to an exemplary embodiment of the present invention.

The figure is merely schematic and not true to scale. Identical reference signs refer to identical or identically acting features.

### DETAILED DESCRIPTION OF EXAMPLE EMBODIMENTS

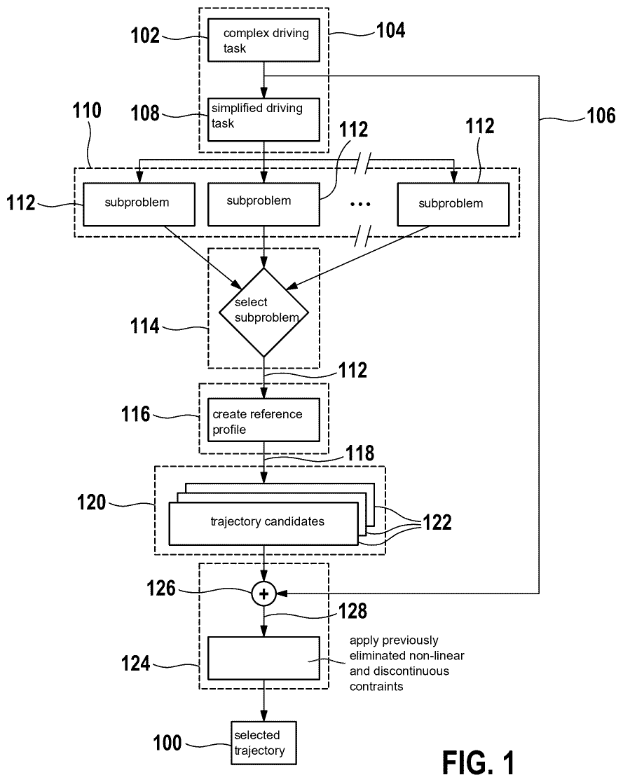

FIG. 1 shows a method sequence of a method according to an exemplary embodiment of the present invention. The method is executed on a control unit of a vehicle. The control unit can, for example, be configured to steer the vehicle autonomously or at least semiautonomously along a trajectory 100. The method generates the trajectory 100 for the vehicle in order to complete a complex driving task 102. For this purpose, in a first step 104, nonlinear and discontinuous constraints 106 are extracted from the driving task 102 and eliminated from the driving task 102 in order to obtain a simplified driving task 108. Then, in a second step 110, the simplified driving task 108 is subdivided, for example into three subproblems 112 in this case. In a third step 114, one of the subproblems 112 is selected. In a fourth step 116, a reference profile 118 is created for the selected subproblem 112. In a fifth step 120, multiple trajectory candidates 122 are then determined using the reference profile 118. The trajectory candidates 122 each solve the selected subproblem 112. Subsequently, in a sixth step 124, the previously eliminated nonlinear and discontinuous constraints 106 are applied to the trajectory candidates 122, and a comparison 126 of the constrained trajectory candidates 122 is carried out. Based on a result 128 of the comparison 126, the trajectory 100 is then selected.

Possible embodiments of the present invention are summarized again below or described using slightly different words.

A method for efficient hierarchical trajectory generation is presented.

In the coming years, partially, highly or fully automated driving functions will increasingly be used in modern vehicles. This can relieve the burden on the human driver and reduce the risk of accidents. Examples of functions include already available systems, such as adaptive cruise/lane keeping assist, as well as systems from the field of highly and fully automated driving, such as highway pilots or so-called robotaxis for urban areas.

What these functions have in common is that an environmental model is calculated from all available sensor data in order to interpret it according to the locally applicable traffic regulations. The result of this interpretation is a path with time information (also called a trajectory) that defines the movement of the ego vehicle in question in cooperation with other road users. In addition to numerous comfort criteria and an acceptable driving strategy for the human passenger, kinematic feasibility also determines the movement of the vehicle. The complexity of modern cars and their environment poses a major challenge for real-time capable trajectory calculation. The longitudinal movement is usually determined by the dynamic behavior of the underlying powertrain/braking system. Furthermore, the lateral movement is generally limited by the nonholonomic property of such systems. In addition, certain coupling effects between the longitudinal and lateral movement make the problem of trajectory generation more difficult.

A common approach is to decouple the longitudinal and lateral movements, solve the individual problems using a “brute force” approach (i.e., generate a large number of trajectories by discretizing the potential solution space), combine them, and select the best one according to a predefined cost function. The main advantage here is that the complexity of the boundary conditions and the environment can be implicitly approximated by the above-mentioned discretization and the subsequent combinatorial effects. At the same time, the quality of the solution suffers from the discretized solution space, since it almost always leads to a suboptimal solution when the number of potential solutions is limited to a reasonable number (which is actually required by the currently available computing power of control units).

In the opposite approach, the main idea is to optimize for a single trajectory (or a small number of trajectories) in the 2D space of the lateral/longitudinal movement, directly considering all the constraints mentioned above. Given the natural complexity of the environment in which a typical passenger vehicle must move, solving this problem in real time on currently available control units is very difficult.

Here, a method is provided that allows fast, efficient and accurate calculation of 2D trajectories while being able to take into account complex boundary conditions and environmental conditions that are typical for modern passenger cars. The proposed method in particular takes into account the need for a deterministic runtime and the limited computing power of available control units to expand its potential application range.

Furthermore, the proposed method of the present invention can be easily extended to non-passenger vehicles by adapting the underlying vehicle model (e.g., trucks, buses, tractors, forklifts, snowmobiles, etc.).

The essence of the innovation includes two parts. The first part is the systematic exclusion and separation of secondary conditions in the early phases. This leads to simpler, subdivided optimization problems that can then be solved with higher efficiency and quality.

The second part includes using a hybrid multi-stage approach to solve these subdivided optimization problems. As a result, not only is the convergence of the optimizer improved, but also the advantages of the sample-based approaches are utilized to take into account previously excluded secondary conditions. At the same time, the above-mentioned disadvantages of a discretized solution space (which usually occur in purely sample-based approaches) are avoided.

This decomposition of the complex trajectory optimization problem into simpler subproblems makes it manageable, minimizes the tuning effort, and ultimately allows real-time execution on available control units.

The general scheme of the proposed method of the present invention is shown in FIG. 1. The unique structure of the method makes it possible to integrate common strategies for reducing runtime and improving the traceability and tunability of optimization problems without compromising solution quality.

In the process, nonlinearities and discontinuities in the secondary conditions and costs are reduced. These are generally difficult or impossible to handle in real time for most conventional solvers. Here, this strategy is applied in the first step. The costs and secondary conditions then excluded are taken into account again in the final step.

Furthermore, the cost function is simplified. With a simpler cost function, fewer parameters need to be adjusted and the probability of getting stuck in a suboptimal local minimum is lower. The proposed approach makes use of this, without compromising the solution quality, by tailoring the problem to the currently most important task in the second and the third step.

Then the size of the optimization problem is reduced. The time to solve the optimization problem (i.e., the number of optimization steps) scales with the order of the underlying model, the number of optimized variables, and the secondary conditions. Depending on the underlying algorithm, this can even increase exponentially and make the problem virtually unsolvable. The second and the fourth step describe how the system order is reduced in order to keep the problem solvable and manageable.

Finally, the solver is initialized. The number of required iterations of the solver is reduced by proving a good initial solution, as described in the fourth and the fifth step.

Overall, the proposed approach is real-time capable on available control units and ensures human-like driving behavior that takes into account all complexities arising from real-world driving scenarios. The proposed approach is explained in detail below.

The problem of optimizing the trajectory for a finite horizon can be defined as follows

$$\begin{matrix}{min}_{u} & J ( u ; {x}_{0} ) = V ( x ( T ) ) + {\int }_{0}^{T} l ( x ( t ) , u ( t ) , t ) dt \\ s . t . & \begin{matrix}\dot{x} ( t ) = f ( x ( t ) , u ( t ) ) , & x ( 0 ) = {x}_{0}\end{matrix} \\ & \begin{matrix}g ( x ( t ) , u ( t ) , t ) = 0 , & {g}_{T} ( x ( T ) ) = 0\end{matrix} \\ & \begin{matrix}h ( x ( t ) , u ( t ) , t ) \leq 0 , & {h}_{T} ( x ( T ) ) \leq 0\end{matrix}\end{matrix}$$

with the state x∈R^{Nx}, the control u∈R^{Nu} and the optimization horizon T. The costs to be minimized consist of the terminal and integral cost functions V:R^{Nx}→R and l:R^{Nx}×R^{Nu}×R→R. The system dynamics are given by f:R^{Nx}×R^{Nu}×R→R. Furthermore, g:R^{Nx}×R^{Nu}×R→R and h:R^{Nx}×R^{Nu}×R→R are the equality and inequality restrictions. The costs and secondary conditions of the general optimization problem are defined as follows.

$$η ( \cdot ) = {η}^{NL} ( \cdot ) + {\sum }_{i = 1}^{M} ( {η}^{t a s {k}_{i}} ( \cdot ) ) + {η}^{common} ( \cdot ) ,$$

Here, η={l, g, h, V} and η^{NL} (⋅) are the highly nonlinear, discontinuous and “unknown” costs/constraints. These can be, for example, constraints resulting from unknown intentions of other road users and can lead to constraints of the form “if/else,” or constraints that cannot be determined in advance, e.g. due to the decomposition of the path into speeds.

η^{taski} (⋅) are the task-related costs/constraints. Different tasks, such as stopping at a traffic light or following a preceding vehicle, can have very different goals (stopping precisely at a stop line vs. maintaining a relatively constant speed while maintaining a time interval). This can lead to discontinuous boundary conditions as well as conflicting requirements for the cost function, making the choice of appropriate terms and weights for a uniform cost function very difficult. Here, i=[1, M], where M refers to the total number of individual tasks into which the original problem can be subdivided.

η^{common}(⋅) are general costs/constraints. These apply regardless of the scenario, for example driving as comfortably as possible, following a reference, and adhering to drive restrictions.

As shown in FIG. 1, these three types of costs are addressed in different phases of the proposed approach.

The method is further developed using the example of 1D longitudinal trajectory planning but can be trivially extended to lateral or combined trajectory planning as well as to other generic optimization formulations.

In the first step, η(⋅)^{NL} is excluded.

For 1D longitudinal movement optimization, complex coupling effects between the lateral and longitudinal movement are excluded (e.g. force loop, time- and speed-dependent constraints, etc.). These are addressed later in the sixth step.

In the second step, the subdivision into subproblems takes place according to the tasks. The first step simplifies the costs and constraints to be taken into account.

$${η ( \cdot )}^{i n t} = {\sum }_{i = 1}^{M} ( {η}^{t a s {k}_{i}} ( \cdot ) ) + {η}^{common} ( \cdot )$$

Here, η(⋅)^{int} is an average, simpler cost function. However, the task-specific constraints

$${\sum }_{i = 1}^{M} ( {η}^{t a s {k}_{i}} ( \cdot ) )$$

mean that the optimization problem cannot be solved because, depending on the scenario, some of them can become inactive. Therefore, the intermediate problem is subdivided into multiple subproblems, each of which is associated with the costs and constraints of a single task.

$$η {( \cdot )}^{i n t i} = {η}^{t a s k i} ( \cdot ) + {η}^{common} ( \cdot )$$

For the 1D longitudinal problem, for example, the problem is subdivided into three tasks (which means M=3), namely, first, following other vehicles, second, obeying the speed limit, and third, stopping at a stop line (traffic light, crosswalk, etc.).

In the third step, the relevant task is selected.

At each planning time step, the relevant task i from M is decided by a heuristic based on an analysis of the given traffic situation (e.g., distance and availability of other vehicles, traffic lights, crosswalks, speed limits, road geometry, etc.). This allows only the tailored subproblem with the boundary conditions η(⋅)^{inti} specific to the selected task i to be used for trajectory generation, which leads to an efficient solution.

In the fourth step, a reference profile is created.

The optimization problem corresponding to the second step can still be quite nonlinear and therefore requires a good initial solution and/or a reference (e.g., following a lead vehicle with a desired time interval). A stable reference allows faster convergence of the subsequent optimization problem and leads to more consistent driving behavior. A reference profile can be generated efficiently in various ways. For example, for simpler tasks, such as stopping at a stop line, the reference profile can be generated based on rules. Alternatively or additionally, the optimization problem can be solved with a reduced task (basically a trade-off between speed and accuracy).

This step is also useful for checking the feasibility of the subproblem, which can then be used to trigger an early abort/fallback maneuver in case of infeasibility.

In the fifth step, optimized 1D trajectory patterns are generated.

In this phase, an additional set of parameters p is introduced into the optimization problem such that each sample j corresponds to the solution of the optimization problem with the costs and constraints given by

$$η {( x , u , t , {p}_{j} )}^{t a s k i} = {η}^{t a s k i} ( x , u , t , {p}_{j} ) + {η}^{common} ( x , u , t , {p}_{j} ) .$$

The parameters to be changed can be the reference profile, the weights of the original cost functions, or a combination of both. By scaling the reference profile calculated in the fourth step, multiple references can be created efficiently.

The sample space is selected so that it explicitly targets the sample and action spaces that are permitted by the constraints η(⋅)^{NL} previously excluded in the first step. For example, to meet the requirements for higher lateral acceleration, the sample set of the 1D longitudinal trajectory should contain enough samples with low longitudinal acceleration (to allow for a certain lateral acceleration). This counteracts the exclusion of nonlinear constraints made in the first step.

Using the reference profile from the fourth step as the initial solution allows the use of a more complex or higher-order model for the generation of 1D trajectories, ensuring smooth and drivable trajectories.

In the sixth step, the best trajectory is selected taking into account η(⋅)^{NL}.

The created trajectories are finally checked based on the cost and constraint set η(⋅)^{NL}. Careful generation of trajectories in the fifth step maximizes the probability of finding a feasible trajectory. Since all the trajectories already take into account η^{common}(⋅) and η^{taski}(⋅), the finally selected trajectory is convenient and takes into account all applicable constraints. By increasing the number of samples and varied parameters, the probability of finding a solution close to the optimum of the original problem can be increased.

The presented approach can be used for partially, highly and fully automated driving functions. Since the presented method is versatile, it can be used in trajectory planning and prediction frameworks for cars, trucks, industrial vehicles (e.g. forklifts) or even off-road vehicles.

In general, real-time applications with limited computing power can particularly benefit from the proposed solution.

Finally, it should be pointed out that terms like “having,” “comprising,” etc. do not exclude other elements or steps and terms like “a” or “an” do not exclude a plurality.

What is claimed is:

1. A method for generating a trajectory for a vehicle, the method comprising the following steps:
simplifying a driving task to be completed by the trajectory by extracting nonlinear and discontinuous constraints and eliminating the nonlinear and discontinuous constraints from the driving task n order to obtain a simplified driving task;
subdividing the simplified driving task into at least two different subproblems;
creating a reference profile for one of the subproblems;
determining at least two trajectory candidates for the subproblem for which the reference profile was created using the reference profile;
comparing the trajectory candidates with the eliminated constraints; and
selecting a trajectory to be executed for the vehicle using a result of the comparison.

2. The method according to claim 1, wherein a current importance is determined for each of the subproblems, and the reference profile is created for the subproblem of the subproblems with a greatest importance.

3. The method according to claim 2, wherein the importance of each subproblem is determined using a heuristic based on a current traffic situation.

4. The method according to claim 1, wherein the reference profile is created with reduced requirements in comparison with the one of the subproblems.

5. The method according to claim 1, wherein a feasibility of the reference profile is checked, and wherein the method is aborted and restarted when the reference profile is not feasible.

6. The method according to claim 1, wherein the trajectory candidates are derived from the reference profile by varying at least one parameter of the reference profile.

7. The method according to claim 1, wherein the trajectory candidates are derived from the reference profile by varying a number of parameters of the reference profile.

8. A control unit configured to carry out, implement and/or control, a method for generating a trajectory for a vehicle, the method comprising the following steps:
simplifying a driving task to be completed by the trajectory by extracting nonlinear and discontinuous constraints and eliminating the nonlinear and discontinuous constraints from the driving task n order to obtain a simplified driving task;
subdividing the simplified driving task into at least two different subproblems;
creating a reference profile for one of the subproblems;
determining at least two trajectory candidates for the subproblem for which the reference profile was created using the reference profile;
comparing the trajectory candidates with the eliminated constraints; and
selecting a trajectory to be executed for the vehicle using a result of the comparison.

9. A non-transitory machine-readable storage medium on which is stored a computer program for generating a trajectory for a vehicle, the computer program, when executed by a computer, causing the computer to perform the following steps comprising:
simplifying a driving task to be completed by the trajectory by extracting nonlinear and discontinuous constraints and eliminating the nonlinear and discontinuous constraints from the driving task n order to obtain a simplified driving task;
subdividing the simplified driving task into at least two different subproblems;
creating a reference profile for one of the subproblems;
determining at least two trajectory candidates for the subproblem for which the reference profile was created using the reference profile;
comparing the trajectory candidates with the eliminated constraints; and
selecting a trajectory to be executed for the vehicle using a result of the comparison.
